(19) United States
(12) Patent Application Publication
(10) Pub. No.: US 2010/0107117 A1
(43) Pub. Date: Apr. 29, 2010

(54) METHOD, APPARATUS AND SYSTEM FOR PRESENTING METADATA IN MEDIA CONTENT

(75) Inventors: James Edward Pearce, Silchester (GB); Scott Allan Libert, Lihue, HI (US); Richard John Dehoff, Hillsboro, OR (US)

Correspondence Address: Robert D. Shedd, Patent Operations;THOMSON Licensing LLC, P.O. Box 5312, Princeton, NJ, 08543-5312, US

(73) Assignee: THOMSON LICENSING a corporation

(21) Appl. No.: 12/450,780

(22) PCT Filed: Dec. 17, 2007
(86) PCT No.: PCT/US2007/025777

§ 371 Date: Oct. 13, 2009

Related U.S. Application Data
(60) Provisional application No. 60/923,359, filed on Apr. 13, 2007.

(51) Int. Cl. G06F 3/048

(52) U.S. Cl. 715/790

(57) ABSTRACT

An apparatus, system and method for displaying and browsing metadata in video media is provided including a media timeline and a plurality of individual graphical bars configured for displaying the location and range of individual metadata items along the media timeline. Visual indicators in the graphical bars are provided for indicating and distinguishing at least a location, range and level of overlapping regions of metadata items along the media timeline. Such visual indicators can include, e.g., different degrees of shading or coloring to distinguish between non-overlapping regions and/or various levels of overlap and the like.

### RELATED APPLICATIONS

The present application claims priority from U.S. Provisional Application Ser. No. 60/923,359 entitled, “TIMELINE BASED KEYWORD DISPLAY,” filed on Apr. 13, 2007.

### TECHNICAL FIELD

The present invention generally relates to media metadata, and more particularly, to a apparatus, system and method for providing and displaying metadata, such as keywords, within video media to facilitate, e.g., accessing and browsing of the video media.

### BACKGROUND

Metadata can be generally defined to be data about data. To illustrate, an item of metadata can describe an individual content item or a collection of data including multiple content items. Metadata is utilized to facilitate the understanding, use and management of data in general. The type and quantity of metadata required for effective data management varies with the type of data and its context of use. For example, in the context of a camera where the data is a photographic image, metadata can include the date the photograph was taken and details of the camera settings. On a portable music player, metadata can comprise the album names, song titles and album art embedded in the music files. In an information system where the data comprises the content of computer files, metadata about an individual data item can include the name of the field and its length.

One of the advantages of using metadata is that it can assist in conducting more effective and faster searching of the media in which it is affixed. For example, entering search queries using metadata can help users avoid performing more complex filter operations manually. In broadcast media and related industries, there is a widespread requirement to attach descriptive metadata to media assets. This metadata can describe the content of the media, its authors, or other related information pertaining to the media. Most commonly, descriptive metadata is affixed to an entire media asset; however there is frequently a requirement to attach metadata to temporal or time-related portions of the media asset.

### SUMMARY

In one embodiment according to the present principles, a system and method is provided for presenting, displaying and browsing metadata, such as keywords, attached to temporal regions or points within video media, namely, e.g., high definition or standard definition video. Inventive concepts presented herein include the use of “heat mapping,” mouse ‘roll-overs’ and context menus for improving ease and efficiency of media browsing, as well as effectively addressing and querying overlapping temporal metadata in video media using, e.g., a user interface. Advantageously, browsing even large and complex amounts and layers of metadata is made easier and faster using a system and method according to the present principles.

In one aspect of the present principles, a system for presenting metadata items in a video media display is provided comprising a media timeline, a plurality of individual graphical bars configured for displaying the location and range of individual metadata items along the media timeline, and visual indicators in the graphical bars for indicating and distinguishing at least a range and level of overlapping regions of metadata items along the media timeline. According to another aspect, a method of browsing metadata items in a video media display having a media timeline is provided comprising the steps of selecting at least one metadata item corresponding to a temporal portion of the media timeline, highlighting the selected metadata item on the display, and displaying metadata item information pertaining to the selected metadata item. These, and other aspects, features and advantages of the present principles will be described or become apparent from the following detailed description of the preferred embodiments, which is to be read in connection with the accompanying drawings.

### BRIEF DESCRIPTION OF THE DRAWINGS

In the drawings, wherein like reference numerals denote similar elements throughout the views:

FIG. 1 is an exemplary illustration of a media timeline having assigned temporal metadata;

FIG. 2 is an exemplary illustration of a media timeline having multiple layers of assigned temporal metadata;

FIG. 3 is an exemplary illustration of a media timeline marked with non-overlapping graphical representations of metadata items and a corresponding metadata item list according to an aspect of the present principles;

FIG. 4 is an exemplary illustration of a media timeline including overlapping graphical representations of metadata items according to an aspect of the present principles;

FIG. 5 is an exemplary illustration of a pointing device cursor placed on a non-overlapping metadata item and a corresponding tool tip according to an aspect of the present principles;

FIG. 6 is an exemplary illustration of a pointing device cursor placed on a non-overlapping portion of a metadata item and a corresponding tool tip according to an aspect of the present principles;

FIG. 7 is an exemplary illustration of a pointing device cursor placed on an overlapping portion of two metadata items and a corresponding tool tip according to an aspect of the present principles;

FIG. 8 is an illustration of a context menu corresponding to the tool tip of FIG. 7 according to an aspect of the present principles;

FIG. 9 is an exemplary highlighted region of a graphical representation of a metadata item according to an aspect of the present principles;

FIG. 10 is an exemplary keyword list corresponding to the metadata item selected in FIG. 9;

FIG. 11 is an exemplary flow diagram of a method for presenting and browsing metadata according to an aspect of the present principles; and

FIG. 12 is an exemplary flow diagram of a method for visually distinguishing metadata according to an aspect of the present principles.

It should be understood that the drawings are for purposes of illustrating the concepts of the present principles and are not necessarily the only possible configurations for illustrating the present principles.

### DETAILED DESCRIPTION

A method, apparatus and system for presenting, displaying and browsing metadata in media, particularly video media, is advantageously provided according to various aspects of the present principles. Although the present principles will be described primarily within the context of metadata display and browsing system and method, the specific embodiments of the present principles should not be treated as limiting the scope of the invention. It will be appreciated by those skilled in the art and informed by the teachings of the present principles that the concepts of the present principles can be advantageously applied in metadata presentation and browsing and the like.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that flow charts, flow diagrams, state transition diagrams, pseudo-code, and the like represent various processes which can be substantially represented in computer readable media and so executed by a computer or processor, whether or not such computer or processor is explicitly shown.

In accordance with various embodiments of the present principles, a method, apparatus and system is described for presenting, displaying, browsing and accessing metadata in video media via an interactive graphical user interface which advantageously improves ease of browsing media having large numbers of metadata in the form of “metadata items” or keywords which can overlap each other within the video media.

A “media timeline” can be provided comprising a scrollable timeline representing a length of a media asset, e.g., a video. Metadata can comprise metadata items or “keywords” which can be assigned to appropriate time portions along a media timeline using a visual indicator, e.g., a graphical representation of a metadata item or graphical ‘bar’ which can be displayed on a screen. An individual graphical bar is preferably assigned to each keyword along a portion of the media timeline corresponding to the time duration during which it is applicable.

Each new metadata item or “keyword” which is added results in an additional graphical bar being included in the media timeline at the keyword's appropriate temporal location. If there are keywords in the media timeline that overlap, such regions of overlap can be visually noted via use of visual indicators in the graphical bars. For example, regions of overlap can be distinguished via the use of varying types of shading, colors, etc. as visual indicators in the graphical bars. The shading and/or colors, etc., can further be altered to distinguish the range and levels of overlap. Advantageously, this aspect allows the user to immediately gauge and assess the number of overlapping keywords, the length (range) of overlap, as well as where in the media (video) overlaps are occurring.

During browsing of the media asset, a user can evaluate different keywords via a ‘selection’ process wherein the user ‘clicks on’ the desired keyword region or selects the desired keyword from a corresponding list. In addition, a system and method according to the present principles allows a user to evaluate metadata by providing immediate feedback as to metadata which is under a pointing device cursor, yet not ‘selected.’ For example, the user can simply execute a mouse device to ‘roll-over’ the desired keyword region, which prompts a window or ‘tool tip’ to automatically appear. In either the selected or unselected instances, the desired keyword region is further preferably highlighted in the user interface; in the latter (unselected) instance, as the mouse is moved in between keyword regions, the highlighted region is simultaneously changed (this is a ‘transient highlight’ and advantageously improves the user's ability to select a keyword region).

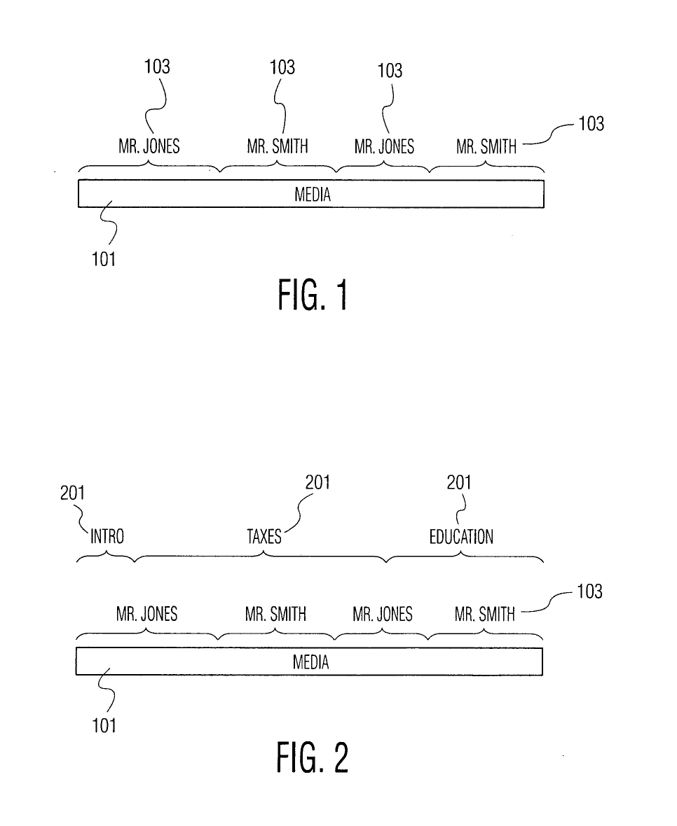

For example, as illustrated in FIG. 1, media comprising a video recording 101 of a debate can have descriptive metadata comprising temporal keywords 103 assigned to the media 101 which, for example, can describe the name of the person who is speaking at a given point in the video stream. These temporal keywords 103 can be indicated on the media timeline 101, and a user can click the representation to obtain more information about that keyword or metadata item 103. As the number of temporal metadata items which are assigned to a given media asset increases, so can the likelihood that some number of the metadata items will overlap. For example, as illustrated in FIG. 2, in addition to assigning keywords 103 for describing who is talking, there can also be a need to attach keywords 201 to the media timeline describing the subject of the debate along temporal portions of the media timeline 101.

There is potentially no end to the amount or types of metadata which can be applied to media. For example, if a sports game is desired to be annotated with metadata, one can describe all the players and their actions throughout the game. One can also describe the advertisements in the background and the clothes each player wears, each fan in the stands and the clothes they wear, etc. Various types of metadata can be added which would be of interest to various parties, such as spectators, sponsors or security officials, and thus even for a simple resource the amount of possible metadata that can be applied can be enormous.

As more keywords overlap in a media timeline, there is a corresponding potentially greater increase in complexity in the organization and presentation of the keywords in the media, as well as increased complications and difficulty in accessing and browsing the metadata by a user. For example, if a user ‘clicks’ on a keyword region where there are overlapping keywords, such a selection can be ambiguous and it would be uncertain as to which keyword is desired by the user.

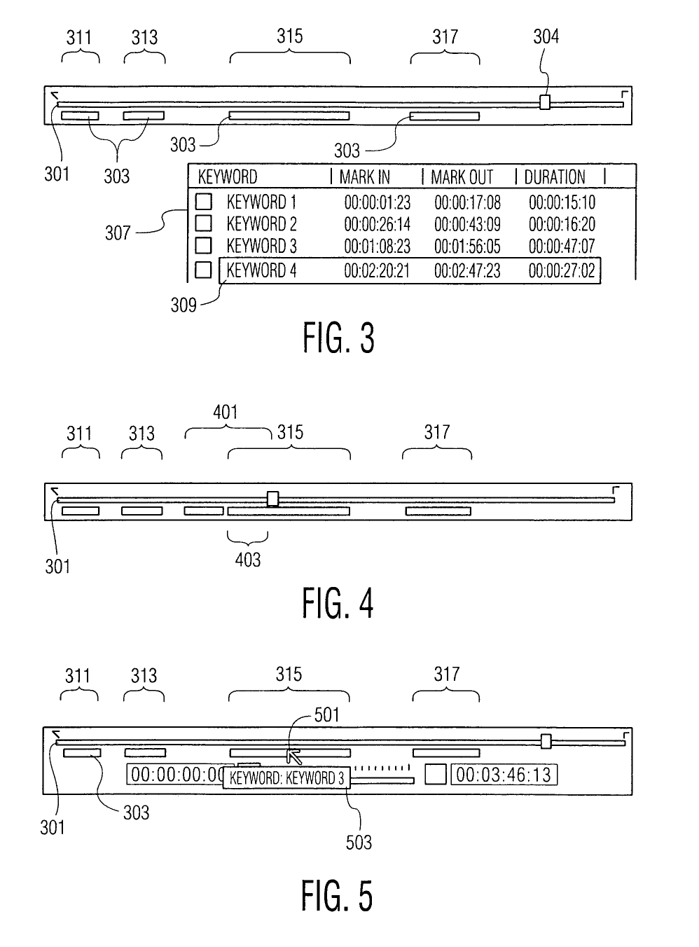

Referring now to the Figures, FIG. 3 is an exemplary illustration of a media timeline 301 marked with non-overlapping graphical bars 303 representing four separate metadata items 311, 313, 315, 317 and a corresponding metadata item list 307 according to an aspect of the present principles. The media timeline 301 can comprise, e.g., an elongated continuous bar displayed on a user interface representing a temporal length of e.g., a video. The timeline 301 can be configured to be scrollable (e.g., from its beginning to end) via a scrollbar ‘thumb’ 304 component. Metadata, e.g., keywords, can be added to the timeline 301 by way of visual indicators such as, e.g., graphical bars 303. The metadata item list 307 can be configured to be displayed contemporaneously with the timeline 301 or opened and accessed by the user separately.

In the example illustrated in FIG. 3, a total of four non-overlapping keywords 311, 313, 315, 317 are shown and the list 307 is simultaneously displayed with the timeline 301. According to one embodiment, a user can tab through and ‘select’ a desired keyword directly on the timeline 301 (e.g., by clicking on them directly via a mouse), or can select the desired entry in the keyword list 307 (e.g., by pressing a key on a keyboard). Both operations are preferably linked, such that changing the selection in one automatically updates the selection in the other. Here, keyword 4 (317) has been selected and is thus highlighted. Accordingly, keyword 4 (309) in the list 307 is also highlighted.

FIG. 4 is an exemplary illustration of a media timeline 301 including overlapping metadata items according to an aspect of the present principles. In this example, a newly added keyword 5 (401) is added to the timeline 301 and partially overlaps an existing keyword (keyword 3 (315)). The range (e.g., time duration) 403 of the overlapping keywords can be visually distinguished by use of visual indicators, such as e.g., at least one of shading, coloring, etc. to distinguish between non-overlapping regions and overlapping keyword regions. For example, the overlapping region 403 can be shaded and/or colored in a shading/hue/pattern having greater intensity and/or different color and/or design than non-overlapping regions.

Further, the level of overlapping regions (the number of overlapping keywords in a given region of overlap) can be visibly indicated and distinguished within a media timeline. That is, overlapping regions having different numbers of overlapping keywords can be distinguished from each other. For example, an overlapping keyword region can be shaded/colored accordingly to distinguish areas in which there are two overlapping keywords vs. three overlapping keywords.

FIG. 5 is an exemplary illustration of a pointing device placed on a non-overlapping metadata item/keyword 315 and a corresponding indicator 503 according to an aspect of the present principles. According to one aspect, a pointing device or mouse ‘roll-over’ highlighting feature and a ‘tool tip’ feature is provided. For example, as a user moves his mouse cursor 501 over each keyword item 311, 313, 315, 317 in a timeline 301, each is automatically highlighted on the screen, e.g., in a different color. In this embodiment, the user does not ‘select’ the keyword (e.g., with a mouse click and/or key strike, as per the embodiment in FIG. 3) but merely places the pointing device cursor over the desired keyword to activate the mouse roll-over highlighting feature; therefore the status of the keyword is herein defined as ‘unselected.’

When a cursor 501 is placed over a keyword (e.g., 315) on the timeline 301, an indicator pop-up window or ‘tool tip’ 503 is contemporaneously displayed which preferably displays more information regarding the highlighted keyword 315. For example, the detailed information in FIG. 5 describes that the highlighted keyword 315 is “Keyword 3.” Note that in this situation, the cursor 501 has been placed over a single, non-overlapping keyword region.

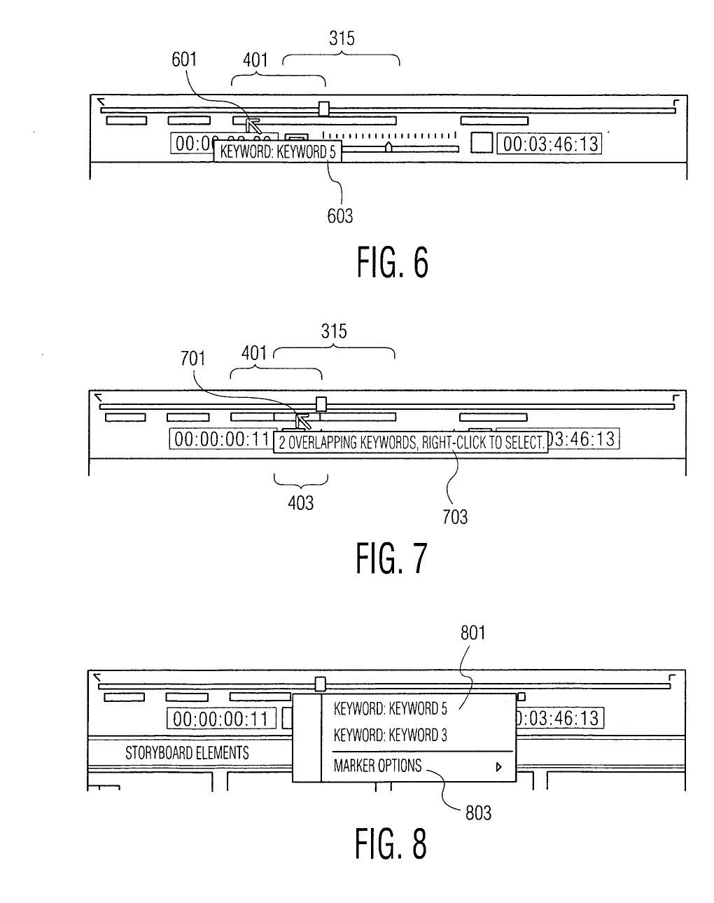

FIG. 6 is an exemplary illustration of a pointing device cursor 601 placed on a non-overlapping portion of a metadata item 401 and a corresponding tool tip 603 according to an aspect of the present principles. Here, the cursor 601 has been placed on a different keyword, which tool tip 603 describes as comprising “Keyword 5.” Note that the cursor 601 is still in a non-overlapping keyword region.

FIG. 7 is an exemplary illustration of a pointing device cursor 701 placed on an overlapping portion 403 of two metadata items 401, 315 and a corresponding displayed tool tip 703 according to an aspect of the present principles. In this example, the cursor 701 is placed over an ambiguous region of interest, due to the overlap of more than one keyword, and tool tip 703 can be configured to describe the ambiguity. For example, tool tip 703 can state “2 overlapping keywords, right-click to select.” Advantageously, tool tip 703 is configured to display information about the overlap, including the number of overlapping keywords, etc., and can further advise the user on how to resolve the ambiguity (e.g., here, by instructing the user to right-click on the mouse). This provides the user with an additional ‘pop-up’ window or listing displaying a context menu, described further below.

FIG. 8 is an illustration of an exemplary context menu 801 corresponding to the tool tip 703 of FIG. 7 according to an aspect of the present principles. The context menu 801 can comprise a listing of all the keywords under a region of overlap and be configured to allow a user to select a desired keyword. The context menu 801 can include an optional “Marker Options” feature 803 which allows a user to switch the keyword rendering and other timeline markers on or off. The context menu 801 can be configured to be displayed due to a user action made on the pointing device (a ‘right-click’) and/or a keyboard command. In this example, the context menu 801 displays two keywords in the overlap region 403. According to one aspect, the region on a graphical bar which corresponds to a selected keyword can be highlighted.

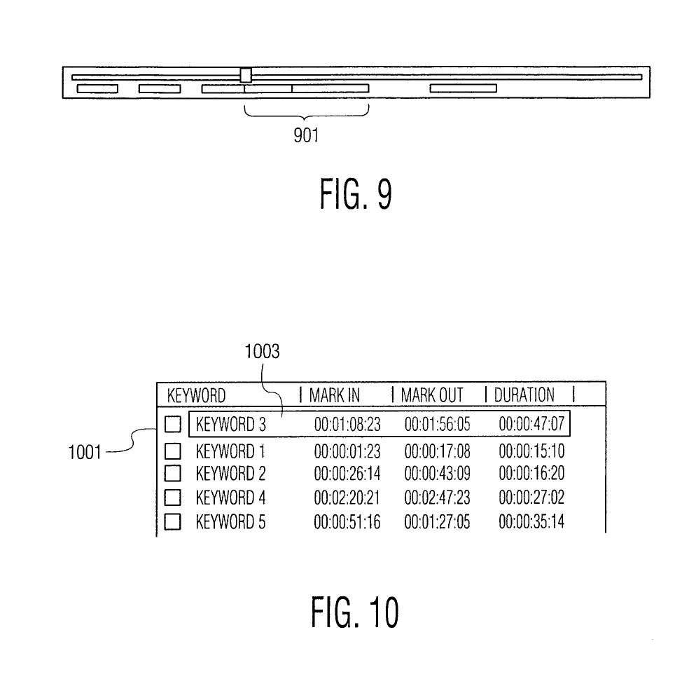

For example, if the user selects “Keyword 5,” the corresponding region 901 can be highlighted (e.g., as shown in FIG. 9, in a different shade or color) to visually distinguish the same from the unselected keyword regions. Optionally, the corresponding keyword in a keyword list can further be highlighted. For example, FIG. 10 is an exemplary keyword list 1001 showing a highlighted metadata item 1003 corresponding to the keyword (‘Keyword 3’) which was selected in FIG. 9.

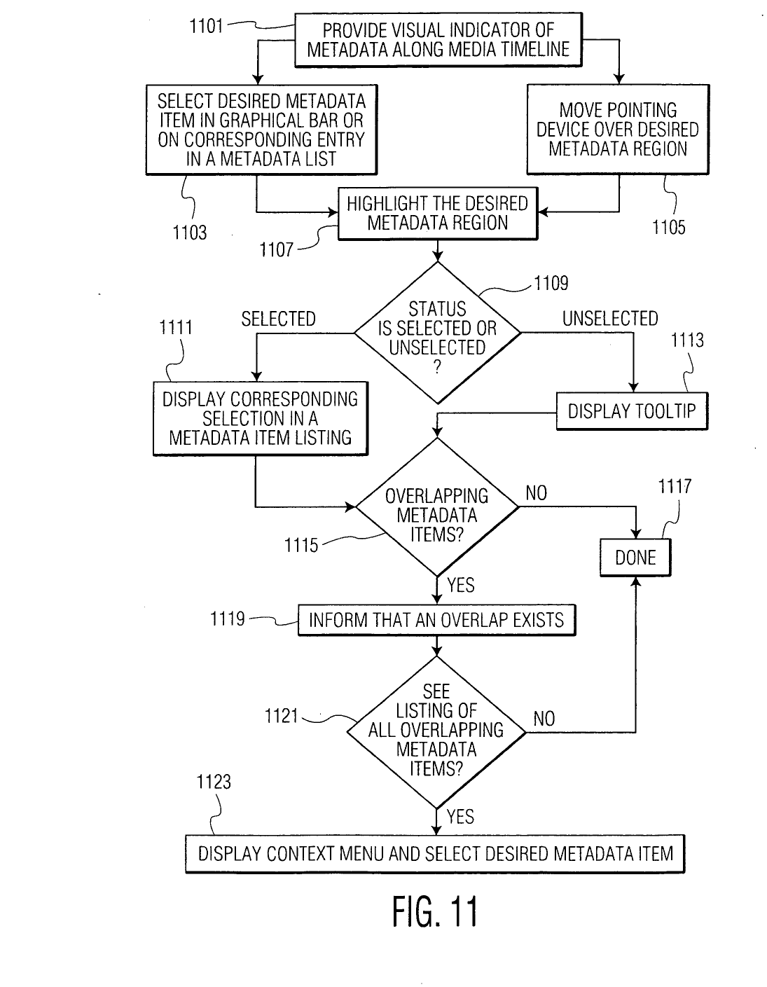

FIG. 11 is an exemplary flow diagram of a method for presenting and browsing metadata according to an aspect of the present principles. In step 1101, a visual indicator (e.g., a graphical representation) of metadata is provided and displayed along a media timeline. For example, a graphical bar can be provided representing a temporal region along the timeline to which each metadata item corresponds. A user can perform either of at least two options, a ‘selecting’ status in which, e.g., he can select a desired metadata item directly on a display (select a graphical bar) or click on a corresponding entry on a metadata list (step 1103). Alternatively, the user can choose an ‘unselected’ status and simply move the pointing device (mouse cursor) over the desired metadata region on the display (step 1105).

In step 1107, the desired metadata region, whether having a ‘selected’ or ‘unselected’ status, is highlighted. In decision box 1109, it is determined whether the status is selected or unselected. If the status is ‘selected,’ a corresponding highlighted selection in a metadata item listing is displayed (step 1111). If the status is ‘unselected,’ a window or tool tip is displayed (step 1113). Advantageously, the ‘unselected’ option provides a means for allowing the user to browse metadata items quickly and automatically displays information about metadata items without requiring keyboard strikes, mouse clicks, etc.

In decision step 1115, it is determined whether there are overlapping metadata items in the desired metadata region. If no, the process is done (step 1117). If yes, the user is informed that at least one overlap exists (step 1119), e.g., by providing such information in the tool tip displayed to the user in step 1113. In decision step 1121 it is ascertained whether the user desires to see a listing of all the overlapping metadata items. If yes, the user can access a context menu showing a listing of all metadata items corresponding to the desired region (step 1123). The user can then select the desired metadata item from the context menu. If no, the process is done (step 1117).

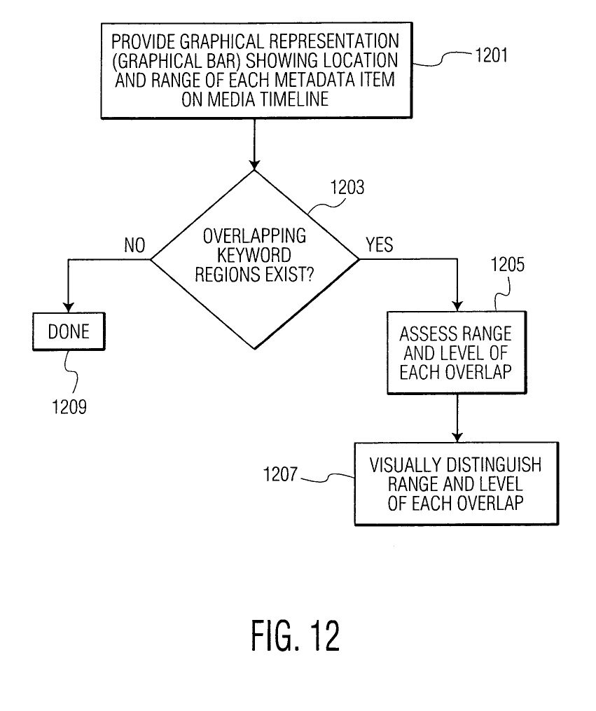

FIG. 12 is an exemplary flow diagram of a method for visually distinguishing metadata as defined in step 1101 of FIG. 11 according to an aspect of the present principles. In step 1201, graphical representations (e.g., graphical bars) of metadata items (e.g., keywords) are provided and added to a media timeline. Each graphical bar preferably comprises a temporal representation of each keyword along the media timeline. In decision box 1203, it is determined whether overlapping keyword regions exist. If no, the process is done (step 1209). If yes, a range (temporal amount) and level (number of overlapping keywords) of each overlap is assessed (step 1205). The resultant determined range and level of each overlap is visually indicated and distinguished on the media timeline.

For example, different numbers of overlapping keywords in a single region on a graphical bar can be visually distinguished from each other. In this regard, the use of “heat maps” can be employed according to one inventive aspect, in which the color of the graphical bar can be caused to become incrementally ‘hotter’ where an overlap exists. To illustrate, a region having two overlapping keywords can be colored in light blue, while a region having three overlapping keywords can be colored a deeper blue, and a region having four overlapping keywords can be colored an even darker blue, and so on. Different colors or intensities of a single color can be utilized to visually distinguish different levels of overlap. Advantageously, this mechanism allows the user to immediately gauge and assess the number of overlapping keywords, the length (range) of overlap, as well as where in the media (video) overlaps are occurring.

Although the embodiment which incorporates the teachings of the present principles has been shown and described in detail herein, those skilled in the art can readily devise many other varied embodiments that still incorporate these teachings. Having described preferred embodiments for a system and method for displaying and browsing timeline-based metadata (which are intended to be illustrative and not limiting), it is noted that modifications and variations can be made by persons skilled in the art in light of the above teachings. It is therefore to be understood that changes can be made in the particular embodiments of the principles disclosed which are within the scope and spirit of the inventive principles as outlined by the appended claims. Having thus described the invention with the details and particularity required by the patent laws, what is claimed and desired protected by Letters Patent is set forth in the appended claims.

1. A system for presenting metadata items in video, comprising:
a media timeline;
a plurality of individual graphical bars for indicating the location and range of individual metadata items along the media timeline; and
visual indicators in the graphical bars for indicating at least one of a range and a level of overlapping regions of metadata items along the media timeline.

2. The system of claim 1, wherein the metadata items comprise keywords.

3. The system of claim 1, wherein the range of overlapping regions comprises a duration of time during which each metadata item overlaps each other along the media timeline.

4. The system of claim 1, wherein the level of the overlapping regions comprises a number of overlapping metadata items.

5. The system of claim 1, wherein the visual indicators comprise at least one of shading or coloring provided to distinguish between non-overlapping regions and various levels of overlap.

6. The system of claim 5, wherein the shading or coloring is intensified with each level of overlapping metadata items.

7. The system of claim 1 further comprising a pointing device-activated highlighting feature, configured for highlighting a metadata item when a pointing device is placed over its corresponding graphical bar.

8. The system of claim 7 further comprising a tool tip window configured to be automatically displayed when each metadata item is highlighted, the tool tip window showing information for each highlighted metadata item.

9. The system of claim 1, further comprising a context menu for providing at least a listing of all the metadata items pertaining to a region of overlapping metadata items.

10. A method, comprising:
utilizing indicators associated with media content to indicate overlapped temporal metadata attached to points within the media content; and
employing interactive mechanisms that allow retrieval of the metadata by interacting with the indicators.

11. The method of claim 10 further comprising:
visually representing metadata items along media timeline;
selecting at least one metadata item corresponding to a temporal portion of the media timeline;
highlighting the selected metadata item; and
displaying metadata item information pertaining to the selected metadata item.

12. The method of claim 11 further comprising:
utilizing a keyword as the metadata item.

13. The method of claim 11 further comprising:
selecting and displaying metadata item information by:
scrolling to a desired metadata item;
providing a metadata item listing having at least the desired metadata item in the listing;
clicking directly on the desired metadata item or on the corresponding metadata item shown in the metadata item listing.

14. The method of claim 11 further comprising:
selecting at least one metadata item by moving a pointing device over a desired metadata item on the display.

15. The method of claim 14 further comprising:
automatically displaying a tool tip window when the pointing device is moved over the desired metadata item, the tool tip window showing information for each highlighted metadata item.

16. The method of claim 11 further comprising:
visually distinguishing at least a range and level of overlapping regions of metadata items along the media timeline.

17. The method of claim 16 further comprising:
utilizing a range of overlapping regions that comprises a duration of time during which each metadata item overlaps each other along the media timeline.

18. The method of claim 16 further comprising:
utilizing a level of overlapping regions that comprises a number of overlapping metadata items.

19. The method of claim 16 further comprising:
visually distinguishing the region of overlap by providing different shades or colors to distinguish between non-overlapping regions and regions having various levels of overlap.

20. The method of claim 19 further comprising:
intensifying shading or coloring with each level of overlapping metadata

21. The method of claim 16 further comprising:
displaying a context menu for listing at least all the metadata items pertaining to a region of overlapping metadata items.
